(19) United States
(12) Patent Application Publication
(10) Pub. No.: US 2024/0288942 A1
(43) Pub. Date: Aug. 29, 2024

(54) Five Way Haptics Scroll Button Finger Guidance and Scroll Profiles for Mouse and Keyboard

(71) Applicant: Dell Products L.P., Round Rock, TX (US)

(72) Inventors: Wong Hin Loong Justin, Singapore (SG); Kai Leong Wong, Singapore (SG); Derek Jeffrey Ho, Singapore (SG)

(73) Assignee: Dell Products L.P., Round Rock, TX (US)

(21) Appl. No.: 18/113,454

(22) Filed: Feb. 23, 2023

(51) Int. Cl. G06F 3/01; G06F 3/0362; G06F 3/038

(52) U.S. Cl. CPC G06F 3/016; G06F 3/0362; G06F 3/038

(57) ABSTRACT

Described herein is a peripheral device, such as a mouse or keyboard for scrolling through applications of an information handling system. A scrolling profile is selected by a button or key, and an indication is provided as to the selected scrolling profile. Navigation is provided by a rigid scroll button configured to a five-way toggle and haptics motor. Scrolling is based on the selected scrolling profile which includes specific scrolling parameters.

### BACKGROUND OF THE INVENTION

### Field of the Invention

The present invention to peripherals for interfacing with information handling systems. More specifically, embodiments of the invention provide a mouse or keyboard that implement five way haptics with fast and ultra-fast scroll functionality.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A popular user interface and information handling system peripheral are the computer mouse and keyboard. The computer mouse allows a user to interface with software applications running on the information handling system by manipulating the mouse through the hand of the user. The mouse can transmit physical gestures to actions performed by the software application. In a similar manner, the keyboard allows for a user to interface with the software applications, by pressing down on navigation keys of the keyboard.

A design of the mouse provides that when a user presses a scroll button to go forward or backward, scroll actuation is performed to go up (forward) or down (backward). The amount of the finger grip becomes dependent on the frictional force between the user's finger and the scroll button surface. In certain cases, this can result in slippage of a user's finger on the surface of the scroll button, or a greater press down force is needed on the scroll button to properly grip the scroll button. A higher perpendicular force may be applied to increase frictional force between the finger and scroll button surface.

The mouse may have a profile that provides for a sequential order of increasing scroll speed, with a process of scroll parameter customization, where a single mouse click goes to fast scroll, another mouse click goes to ultra-fast scroll. The user would have to cycle through the states in sequence. Such a profile does not allow the user to stay in fast scroll, where the user desires to fast scroll to search longer while being able to vies contents of a scrolling screen. Such a profile does not allow the user to move directly to ultra-fast scroll, when the user desires to move to go to a desired search location, such as a few pages away within a multipage document, site, etc.

A keyboard can provide for scrolling with the use of four arrow navigation keys (e.g., up, down, left and right), and can be used for browsing/navigation through applications. When an array key is pressed and held down, the maximum scroll speed is set by a pulsating rate of key actuation, where pulsating rate is fixed by an operating system of the information handling system. For example, the pulsating rate can be repeatable at two lines/sec. The scroll speed cannot be increased.

### SUMMARY OF THE INVENTION

A peripheral device for scrolling through applications of an information handling system comprising a profile select button to select a scrolling profile; a semi-circular scroll button to navigate through the applications based on the selected scrolling profile; a five-way toggle configured to receive input the semi-circular scroll button; and a haptics motor configured to the five-way toggle providing feedback based on the input of the semi-circular scroll button and selected scrolling profile.

A computer-implementable method and computer-readable storage medium for implementing a peripheral to scroll through applications of an information handling system comprising receiving input to select a scrolling profile of various scrolling profiles through a profile select button; indicating the selected scrolling profile by one or more LEDs; implementing the scroll profile based on or more parameters; and receiving input from a scroll button to navigate through the applications based on the scroll profile.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the present invention;

FIG. 2 illustrates a mouse with five way haptics and scroll profiles;

FIG. 3 illustrates a keyboard with five way haptics and scroll profiles;

FIG. 4 is an exploded view of a five way haptics scroll button with scroll profiles;

FIG. 5 illustrates a system block diagram of a peripheral implementing five way haptics with fast and ultra-fast scroll functionality;

FIG. 6 illustrates a mouse state machine diagram;

FIG. 7 is a generalized flowchart for profile scrolling; and

FIG. 8 is a generalized flowchart for implementing a peripheral with a selected scrolling profile.

### DETAILED DESCRIPTION

Various implementations provide for a mouse or keyboard with a five way haptics scroll button that provides for fast/ultra-fast scrolling functionality. Various scrolling profiles are provided. The five way haptics scroll button provides for a scroll up, by pressing the scroll button forward and releasing the scroll button. Scroll down by pressing the scroll button backward and releasing the scroll button. Scroll left by pressing the scroll button to the left and releasing the scroll button. Scroll right by pressing the scroll button to the right and releasing the scroll button. Fast scroll up by pressing the scroll button forward and holding for “x” number of seconds. Ultra-fast scroll up by pressing the scroll button forward and holding for “X” (X>x)) number of seconds. Haptics vibration is provided by a linear resonant actuator (LRA) motor during fast or ultra-fast scroll.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

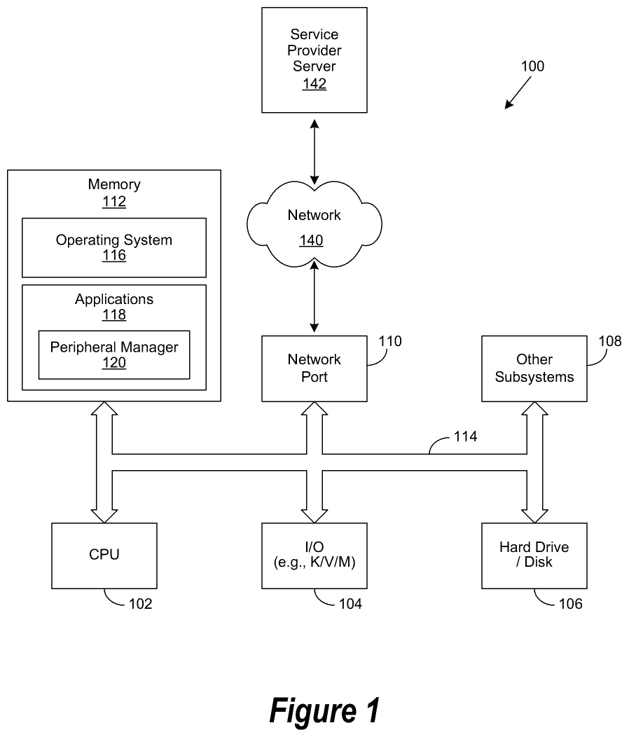

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a microphone, a keyboard, a video/display, a mouse, and associated controllers (e.g., K/V/M), a hard drive or disk storage 106, and various other subsystems 108. In various embodiments, I/O devices 104 include the wireless mouse described herein, which is connected to the adapter described herein. The wireless mouse and adapter connected via a wireless connection, such as standards defined by IEEE 802.11.

In various embodiments, the information handling system 100 also includes network port 110 operable to connect to a network 140, where network 140 can include one or more wired and wireless networks, including the Internet. Network 140 is likewise accessible by a service provider server 142. The information handling system 100 likewise includes system memory 112, which is interconnected to the foregoing via one or more buses 114. System memory 112 can be implemented as hardware, firmware, software, or a combination of such.

System memory 112 further includes operating system (OS) 116. In various embodiments, OS 116 manages all of the software and hardware on the information handling system 100. Implementations provide for the system memory 112 to include applications 118, such as applications controlled by a mouse and/or keyboard. Implementations provide for applications 118 to include a peripheral manager 120, further described herein, used to support certain processes.

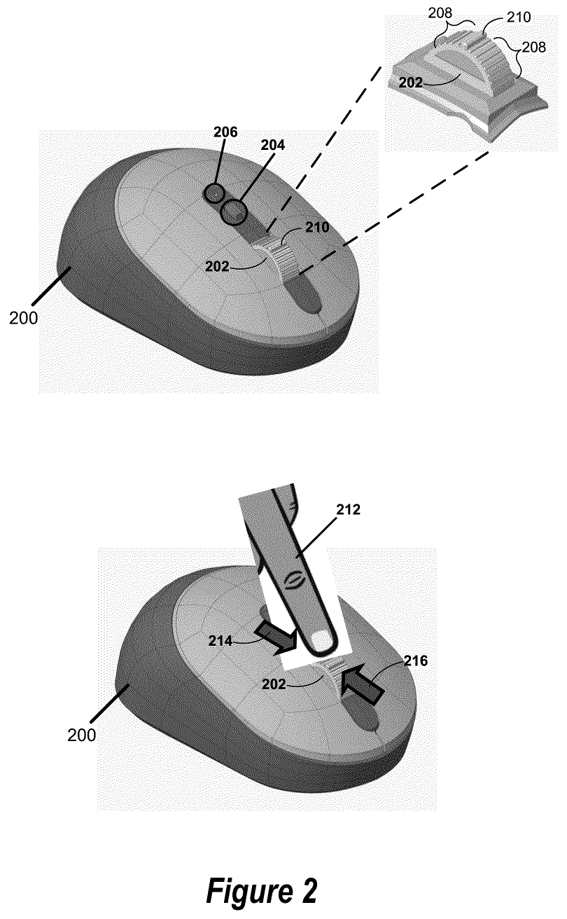

FIG. 2 shows a mouse 200 with five way haptics and scroll profiles. The mouse 200 can be implemented as a wired or wireless mouse, as a peripheral to an information handling system, such as a peripheral or input/output (I/O) device 104 of information handling system 100 described in FIG. 1. Implementations provide for the peripheral manager 120 to interact with the mouse 200 (e.g., provide instructions to and provide/receive data).

Implementations provide for the mouse 200 to include a five way haptics scroll button 202. Instead of a rotating wheel as used in typical mice, implementations provide for the mouse 200 to have a fixed semi-circular scroll button 202 as is further shown and described.

The mouse 200 can include a scroll profile button 204 that can be pressed to change scroll profiles. One or more LEDs 206 can indicate which scroll profile the mouse 200 is in, by blinking, change of color, etc. LEDs 206 can be white/red LEDs.

The five way haptics scroll button 202 can be implemented with ribs 208, providing a tactile surface to a user. A raised rib 210 is implemented as a finger guidance feature for users, allowing users to align their finger on the scroll button 202.

The raised rib 210 can improve grip of a user's finger on the scroll button 202 and allows force to be directly transmitted to the scroll button 202. The force applied on the raised rib 210 would be greater than force applied to any of the other ribs 208. A user finger 202 is applied to the scroll button 202, toggling the scroll button 202 either forward 214 or backward 216.

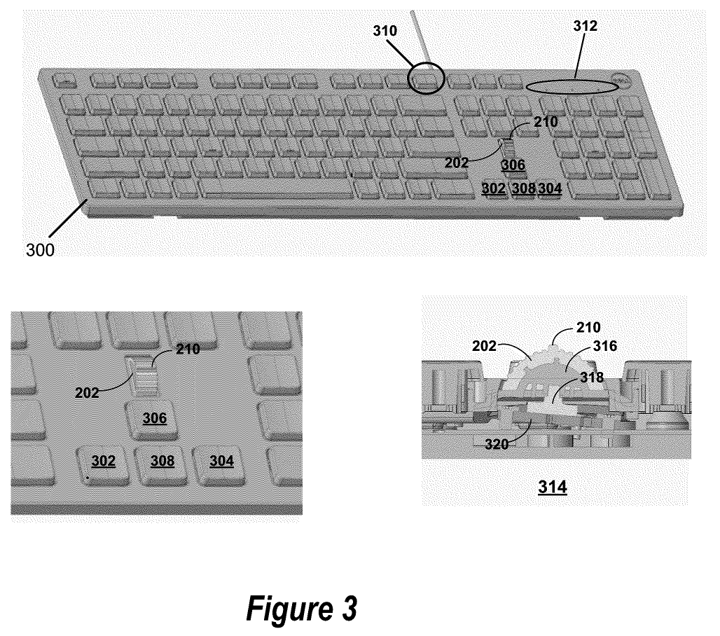

FIG. 3 shows a keyboard 300 with five way haptics and scroll profiles. The keyboard 300 can be implemented as a wired or wireless keyboard, as a peripheral to an information handling system, such as a peripheral or input/output (I/O) device 104 of information handling system 100 described in FIG. 1. Implementations provide for the peripheral manager 120 to interact with the keyboard 300 (e.g., provide instructions to and provide/receive data).

Implementations provide for the keyboard 300 to include the scroll button 202 with the raised rib 210 as described in FIG. 2. The scroll button 202 with the raised rib 210 can be used as described in FIG. 2 as to scrolling forward, backward, left, and right. Implementations also provide for scrolling through four way navigation keys 302, 304, and 306. Arrow key 302 providing for scrolling to the left. Arrow key 304 providing for scrolling to the right. Arrow key 306 providing for scrolling forward. Arrow key 308 providing for scrolling backward.

A key 310 (e.g., function key) can be implemented to select a scroll profile. Implementations provide for the keyboard 300 to include a LED light pipe or LEDs 312 to indicate scroll profile by lighting a particular LED, change in color, blinking, etc.

View 314 is a cross sectional view showing the scroll button 202 and raised rib 210. The sectional view 314 further shows a scroll button core 316, five way navigation toggle 318, and a printed circuit assembly (PCA) 320 that interacts with the five way navigation toggle 318.

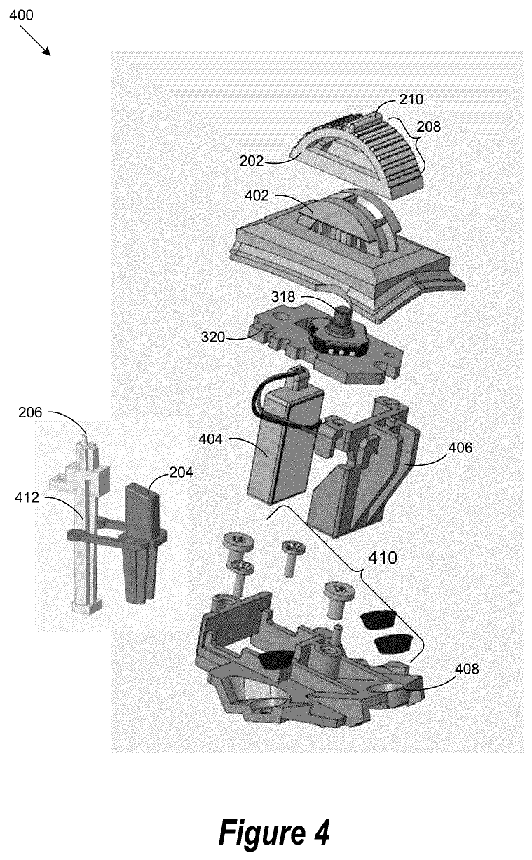

FIG. 4 shows an exploded view 400 of an implementation for a five way haptics scroll button with scroll profiles. The exploded view 400 shows an example hardware assembly implementation of that scroll button 202 as integrated into the mouse 200 or keyboard 300.

As discussed, the scroll button 202 includes ribs 208 and a raised rib 210. The ribs 208 and a raised rib 210 can be molded features of the scroll button 202. The scroll button 202, ribs 208, and raised rib 208 can be rubber/silicon. A scroll button core 402 can be part of the hardware assembly, where the scroll button core 402 can be solid plastic, such as ABS plastic. The scroll button 402 is placed on top of the scroll button core 402.

The hardware assembly implementation further can provide for the scroll button 202 and the raised rib 210 to be in contact with the five way navigation toggle 318. The five way navigation toggle 318 is considered as a tactile switch. A user manipulating the scroll button 202 provides input to the five way navigation toggle 318, which is translated to the PCA 320. The PCA 320 in turn provides input to a linear resonant actuator (LRA) motor 404. Haptics vibration is provided by the LRA motor 404 during fast or ultra-fast scroll. An LRA motor holder 406 can be implemented to secure the LRA motor 404. A scroll button holder 408 and various screws and washers 410 can be implemented to secure hardware implementation.

Various implementations provide profile button 204 to be part of the hardware implementation in mouse 200. An LED light pipe 412 can be configured to profile button 204 and with the LEDs 206. LED light pipe 412 can be implemented as a clear plastic part. As discussed, LEDs 206 can indicate which scroll profile the mouse 200 is in, by blinking, change of color, etc.

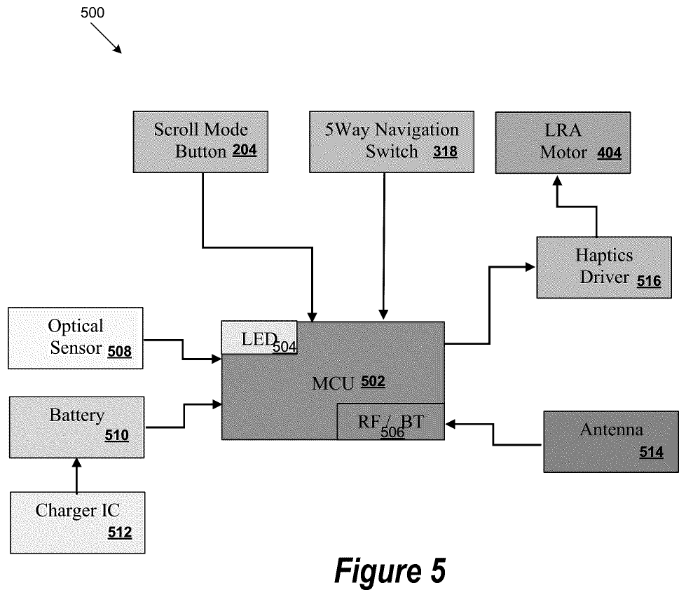

FIG. 5 shows a system block diagram 500 for implementation of the mouse 200 or keyboard 300 (i.e., peripheral) that implements five way haptics with fast and ultra-fast scroll functionality. The scroll mode button 204 of mouse 200 provides an input to a microcontroller unit (MCU) 502. As discussed, the scroll mode button 204 is used indicated/choose a scroll profile. The CU 502 further can receive input from the five way navigation toggle (switch) 318.

Implementations provide (MCU) 502 to be part of PCA 320. The MCU 502 can include an LED 504 and a radio frequency (RF)/Bluetooth (BT) component 506. RF/LT component 506 is particularly used in wireless connections of the mouse 200 or keyboard 300. LED 504 receives input from an optical sensor 508. A battery 510 provides power to the MCU 502. The battery 510 can be charged by a charger integrated circuit 512. An antenna 514 provides input to the RF/BT component 506.

A haptics driver 516 receives input from the MCU 502. The haptics driver 516 in turn provides input to the LRA motor 404. Implementations provide for the haptics driver 516 to be part of PCA 320.

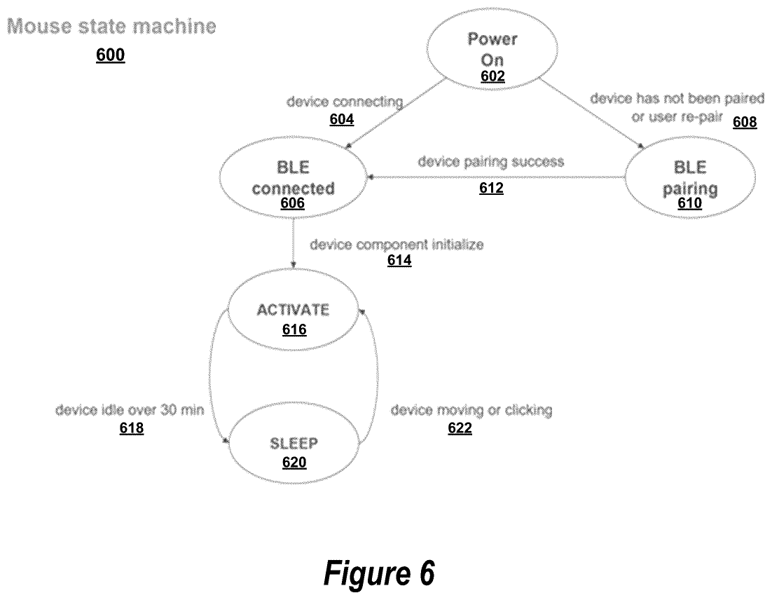

FIG. 6 shows a mouse state machine diagram 600. In particular, the mouse state machine diagram 600 describes wireless operation for the mouse 200 when connecting to a device, such as an information handling system 100. When the mouse is turned on, power on 602, device connecting 602 is performed implementing a Bluetooth low energy (BLE) connection 606. Or if the device has not been paired or user instructs a repairing 608, BLE paring 610 is performed. A successful device pairing 612 leads to BLE connection 606. Device (i.e., mouse 200) component initialization 614 is performed, and activation 616 of the mouse 200 takes place. If the mouse is idle for over 30 minutes 618, the mouse is placed in sleep 620. If the mouse is activated, moved or clicked 622, activation 616 takes place.

In various implementations, different scroll profiles can be provided through an information handling system 100/peripheral manager 120, connected to a peripheral, such as mouse 200 or keyboard 300. Implementations can also provide for the different profiles to be provided by the peripheral (e.g., mouse 200/keyboard 300). The different profiles are based on user preference, customizable to the user. In particular, timing and speed sensitivity are customized as to specific scrolling preference. In various implementations, profiles can be included in firmware of the peripheral (e.g., mouse 200/keyboard 300).

For example, for a scroll profile 1, the profile has three sequential increasing scroll speed zones. This profile can be used for precise scrolling followed by high speed browsing. Scroll speed (e.g., up 1875 scroll lines/see for ultra-fast scroll) can be programmed in peripheral manager 120. A single click (e.g., scroll zone 0) progresses to fast scroll which can be a transition zone (e.g., scroll zone 1), and progress to ultra-fast scroll (e.g., scroll zone 2). The LEDs 206/LEDs 312 can blink according to indicate scroll profile 1.

For a scroll profile 2, the profile stays in fast scroll. The profile 2 can be used for high speed browsing for a longer duration. A single click (e.g., scroll zone 0) transitions to fast scroll (e.g., scroll zone 1). Scroll speed can be programmed in peripheral manager 120. The LEDs 206/LEDs 312 can blink according to indicate scroll profile 1.

For a scroll profile 3, the profile stays in ultra-fast scroll. The profile 3 can be used for high speed browsing for multi-page content (e.g., documents). A single click (e.g., scroll zone 0) transitions to ultra-fast scroll (e.g., scroll zone 2). Scroll speed (e.g., up 1875 scroll lines/see for ultra-fast scroll) can be programmed in peripheral manager 120. The LEDs 206/LEDs 312 can blink according to indicate scroll profile 1.

Implementations provide for profile switching using the scroll profile button 204 for a mouse 200 or key 310 for a keyboard 300. Scroll profile can be indicated by LEDs 206/LEDs 312.

As discussed, scroll profiles can be chosen using the scroll profile button 204 for a mouse 200 or key 310 for a keyboard 300. Scroll profile can be indicated by LEDs 206/LEDs 312. Other methods can also be implemented to choose scroll profiles, and particularly for keyboard 300. Examples include manipulating the navigation keys 302, 304, and 306.

For a four way scroll profile using the navigation keys 302, 304, and 306, using the four navigation keys 302, 304, and 306 can provide similar experience a five way scroll button 202. Scroll profiles can be chosen using the key 310. Continued pressing of key 310 can cycle through various scroll profiles. Choosing the scroll profile can also be performed by actuation of a combination of the navigation keys 302, 304, and 306 (e.g., pressing keys 302 and 304 simultaneously to go to next scroll profile).

Scroll profiles can include scroll profile containers with combinations of various controlling parameters through a sequence of execution and control attributes in the three scroll zones, e.g., click, fast scroll, ultra-fast scroll. The three scroll zones are considered as parameters determining scroll lines/sec. A parameter can be haptic vibration frequency which is haptics vibration/see in scroll zones 1 and 2. A parameter can be haptic strength which is haptics vibration in scroll zones 1 and 2. A parameter can be scroll smoothening which is fractional or whole numbered scroll lines in scroll zones 1 and 2.

Smooth scrolling can allow for better vertical screen transition experience through fractional scroll line movement (e.g., 1/12, ⅙, ¼, ⅓, 5/12, ½, 7/12, ¾ lines). Whole numbered can allow for faster Scroll Speed through full scroll line movement (e.g., 1, 2, . . . 5, . . . 10). Smooth scrolling can be achieved when fractional scroll line is fed through smaller time step to form one scroll (e.g., two pixels per feed in 20 or 30 Hz. Line feed is smoother than sending one solid line scroll feed at end of one second. In contrast, a conventional rotating scroll wheel only allows whole numbered scroll lines movement sent via its detent steps (e.g., 15 degrees detent for 1 or 3 scroll lines).

As discussed, scroll profiles can be chosen using the scroll profile button 204 for a mouse 200 or key 310 for a keyboard 300. Scroll profile can be indicated by LEDs 206/LEDs 312. Other methods can also be implemented to choose scroll profiles, and particularly for keyboard 300. Examples include manipulating the navigation keys 302, 304, and 306.

Scroll profile parameters can further include the following. X0 is a parameter as to time duration of the first click to fast scroll (e.g., scroll zone 1). X1 is a parameter as to time duration of fast scroll (e.g., scroll zone 1) to ultra-fast scroll (e.g., scroll zone 2). Y1 is a parameter as to scroll frequency of fast scroll. Y2 is a parameter as to scroll frequency of ultra-fast scroll. Q1 is a parameter as to smooth factor at X1 zone (e.g., scroll zone 1). Q2 is a parameter as to smooth factor at X2 zone (e.g., scroll zone 2). CRT is first click release time. Z1 is a parameter as to vibrator frequency of mouse scroll during fast scroll. Z2 is a parameter as to vibrator frequency of mouse scroll during ultra-fast scroll. S is vibrator strength of mouse scroll. F is scroll of first click to enable/disable.

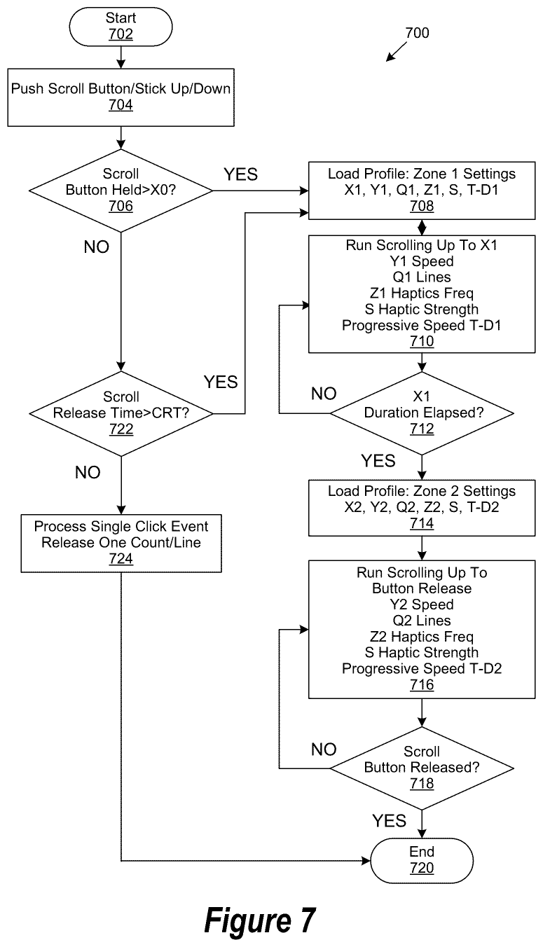

FIG. 7 is a generalized flowchart for profile scrolling. The order in which the method is described is not intended to be construed as a limitation, and any number of the described method blocks may be combined in a y order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At step 702, the process 700 starts. At step 706, a determination is made if a stick, i.e., the scroll button 202 is depressed for greater than X0, time duration of the first click to fast scroll. If the time is greater than X0, follow the NO branch of step 706, step 708 is performed. At step 708, a profile is loaded, as to Zone 1 settings, with values of X1, Y1, Q1, Z1, S, and T-D1 (progressive speed zone 1). At step 710, scrolling is run up to X1 with Y1 scrolling frequency, Q1 lines, Z1 haptics frequency, S haptics strength, and progressive speed T-D1.

At step 712, a determination is made if X1 duration has elapsed. If X1 duration has not elapsed, then following the NO branch of step 712, step 710 is performed. If X1 duration has not elapsed, then following the YES branch of step 712, step 714 is performed. At step 714, a profile is loaded, as to Zone 2 settings, with values of X2, Y2, Q2, Z2, S, and T-D2 (progressive speed zone 2). At step 716, scrolling is run up to scroll button release with Y2 scrolling frequency, Q2 lines, Z2 haptics frequency, S haptics strength, and progressive speed T-D2.

At step 718, a determination is made if the scroll button is released. If the scroll button is released, then following the NO branch of step 718, step 716 is performed. If the scroll button is released, following the YES branch of step 718, at step 720, the process 700 ends.

If the time the scroll button is not greater than X0, follow the NO branch of step 706, step 722 is performed. At step 722, a determination is performed as to whether scroll release is greater than CRT. If scroll release is greater than CRT, following the YES branch of 722, step 708 is performed. If scroll release is less than CRT, following the NO branch of 722, step 724 is performed. At step 724, a single click event is processed with one/line release. At step 720, the process 700 ends.

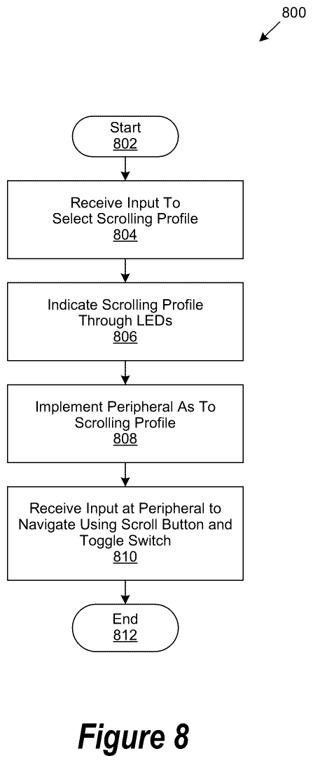

FIG. 8 is a generalized flowchart for implementing a peripheral, such as the mouse 200 or keyboard 300 with a selected scrolling profile. The order in which the method is described is not intended to be construed as a limitation, and any number of the described method blocks may be combined in an y order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At step 802, the process 800 starts. At step 804, input is received to select a specific scrolling profile of various scrolling profiles. The input can be received by activating/depressing the scroll profile button 204 of the mouse 200, or a key 310 of the keyboard 300.

At step 806, the selected scrolling profile is indicated. The indication can be by LEDs 206 of the mouse 200 or LEDs 312 of the keyboard 300. As discussed, the LEDs 206 or LEDs 312 by changing in color, blinking, etc.

At step 808, the peripheral (e.g., mouse 200 or keyboard 300) is implemented based on the selected scrolling profile. The implementation is based on particular parameters of the selected scrolling profile.

At step 810, input is received at the peripheral to navigate through a scroll button, such as scroll button 202 and a toggle switch, such as five way navigation toggle 318. At step 812, the process 800 ends.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

1. A peripheral device for scrolling through applications of an information handling system comprising:
a profile select button to select a scrolling profile, wherein the scrolling profile is defined by one or more of the following parameters: time duration of a first click to a first scroll rate, time duration of the first scroll rate to a faster scroll rate, scroll frequency of first scroll rate, scroll frequency of the faster scroll rate, smooth factor at a scroll zone 1, smooth factor as to a scroll zone 2, first click release time, vibrator frequency of scroll during the first scroll rate, vibrator frequency of mouse scroll during the faster scroll rate, vibrator strength of mouse scroll, scroll of first click to enable/disable;
a semi-circular scroll button to navigate through the applications based on the selected scrolling profile;
a five-way toggle configured to receive input from the semi-circular scroll button; and
a haptics motor configured to the five-way toggle through a printed circuit assembly (PCA) providing haptics vibration feedback based on the input of the semi-circular scroll button and selected scrolling profile.

2. The peripheral device of claim 1, wherein the peripheral device is a mouse or keyboard.

3. The peripheral device of claim 1, wherein the profile select button is a button on a mouse or a function key on a keyboard.

4. The peripheral device of claim 1, wherein the scrolling profiles includes parameters as to scrolling speed, haptics strength, haptics strength, and/or line resolution.

5. The peripheral device of claim 1, wherein the scroll button includes multiple ribs and a raised rib to provide tactile input to a user.

6. The peripheral device of claim 1 further comprising one or more LEDs that indicate the selected scrolling profile.

7. The peripheral device of claim 1, wherein the haptics motor is a linear resonant actuator (LRA) motor.

8. A computer-implementable method for implementing a peripheral to scroll through applications of an information handling system comprising:
receiving input to select a scrolling profile of various scrolling profiles through a profile select button, wherein the scrolling profile is defined by one or more of the following parameters: time duration of a first click to a first scroll rate, time duration of the first scroll rate to a faster scroll rate, scroll frequency of first scroll rate, scroll frequency of the faster scroll rate, smooth factor at a scroll zone 1, smooth factor as to a scroll zone 2, first click release time, vibrator frequency of scroll during the first scroll rate, vibrator frequency of mouse scroll during the faster scroll rate, vibrator strength of mouse scroll, scroll of first click to enable/disable;
indicating the selected scrolling profile by one or more LEDs;
implementing the scroll profile based on or more parameters;
receiving input from a scroll button to navigate through the applications based on the scrolling profile; and
providing haptics vibration feedback through a haptics motor based on the scrolling profile.

9. The computer-implementable method of claim 8, wherein the peripheral device is a mouse or keyboard.

10. The computer-implementable method of claim 8, wherein the profile select button is a button on a mouse or a function key on a keyboard.

11. The computer-implementable method of claim 8, wherein the one or more parameters include scrolling speed, haptics strength, haptics strength, and/or line resolution.

12. The computer-implementable method of claim 8, wherein the scroll button is configured to a five-way toggle and haptics motor to provide haptics feedback.

13. The computer-implementable method of claim 9, wherein the haptics motor is a linear resonant actuator (LRA) motor.

14. The computer-implementable method of claim 8, wherein the scroll button includes multiple ribs and a raised rib to provide tactile input to a user.

15. A non-transitory, computer-readable storage medium embodying computer program code, the computer program code comprising computer executable instructions configured for implementing a peripheral to scroll through applications of an information handling system:
receiving input to select a scrolling profile of various scrolling profiles through a profile select button, wherein the scrolling profile is defined by one or more of the following parameters: time duration of a first click to a first scroll rate, time duration of the first scroll rate to a faster scroll rate, scroll frequency of first scroll rate, scroll frequency of the faster scroll rate, smooth factor at a scroll zone 1, smooth factor as to a scroll zone 2, first click release time, vibrator frequency of scroll during the first scroll rate, vibrator frequency of mouse scroll during the faster scroll rate, vibrator strength of mouse scroll, scroll of first click to enable/disable;
indicating the selected scrolling profile by one or more LEDs;
implementing the scroll profile based on or more parameters; and
receiving input from a scroll button to navigate through the applications based on the scroll profile.

16. The non-transitory, computer-readable storage medium of claim 15, wherein the peripheral device is a mouse or keyboard.

17. The non-transitory, computer-readable storage medium of claim 15, wherein the profile select button is a button on a mouse or a function key on a keyboard.

18. The non-transitory, computer-readable storage medium of claim 15, wherein the one or more parameters include scrolling speed, haptics strength, haptics strength, and/or line resolution.

19. The non-transitory, computer-readable storage medium of claim 15, wherein the scroll button is configured to a five-way toggle and haptics motor to provide haptics feedback.

20. The non-transitory, computer-readable storage medium of claim 15, wherein the scroll button includes multiple ribs and a raised rib to provide tactile input to a user.
